(19) United States
(12) Patent Application Publication
(10) Pub. No.: US 2009/0148239 A1
(43) Pub. Date: Jun. 11, 2009

(54) Resilient protection of through-foundation pipes

(76) Inventor: Gary M. Hickey, II, West Gardiner, ME (US)

Correspondence Address: Charles F. Seyboldt, 19 Ridgeview Drive, Standish, ME, 04084-5338, US

(21) Appl. No.: 12/315,986

(22) Filed: Dec. 9, 2008

Related U.S. Application Data
(60) Provisional application No. 61/007,092, filed on Dec. 10, 2007.

(51) Int. Cl. F16L 1/038

(52) U.S. Cl. 405/155; 405/184.4

(57) ABSTRACT

A resiliently-mounted through-foundation pipe coupling is provided that is suited for building plumbing applications. The resiliently-mounted coupling assembly is a length of straight plastic pipe preferably with pipe couplings on each end. The combined length of the pipe and associated couplings is selected to roughly match the thickness of the foundation. The combined pipe and associated couplings are covered with and bonded to a relatively thick layer of foam rubber elastomeric material. The combination of pipe and elastomeric layer is placed in the desired position in a foundation form before the foundation is poured. The elastomeric layer cushions the plastic pipe from the forces of being cast in place as the foundation is poured, and also provides resilience to the eventually installed piping system (connected to the through-foundation pipe fitting) against the motion of back-filled soil, and against alignment forces and mechanical loading of attached plumbing.

This application claims the benefit of U.S. Provisional Application No. 61/007,092 filed Dec. 10, 2007.

### BACKGROUND OF THE PRESENT INVENTION

### Summary of the Prior Art

This invention relates to the protection of pipes that pass through foundation walls, and the sealing of foundation through holes, and more particularly to a method of providing a resilient and sealing barrier between a pipe and a cast foundation wherein the combination of pipe coupling and a resilient layer are cast in place in a building foundation, and the cast-in piece of pipe is in direct contact with the fluid being transported from one side of the foundation wall (or floor) to the other. The design of the through-foundation pipe coupling and resilient barrier can be adapted to fit a wide range of foundation thickness, pipe materials, pipe sizes, and piping attachment means.

The use of resilient materials to simultaneously 1) protect piping and pipe fittings against damage or breakage caused by shifting of piping or shifting of a foundation; and 2) provide a liquid tight seal between the two sides of the foundation wall (or floor) at the through-foundation hole, is well known.

Flexicraft Industries of Chicago, Ill. markets a pair of companion products that, working together, produce a resilient sealed interface between a through-foundation pipe and the foundation. These companion products are a rigid cast in place “Pipe Wall Sleeve” and a later installed “Pipeseal” elastomeric body. After the foundation is complete (with a through-hole being produced and provided by the “Pipe Wall Sleeve”), and after the pipe-fitter has run a section of pipe through this hole, the “Pipeseal” product is wrapped around the outside of the pipe and pushed into “Pipe Wall Sleeve.” The thickness of the “Pipeseal” is such that it contacts the outside diameter of the through-foundation pipe and the inside diameter of the “Pipe Wall Sleeve.” After being pushed into place, the “Pipeseal” is diametrically expanded to obtain radial sealing against both the through-foundation pipe and the “Pipe Wall Sleeve” by the application of axial compression.

By way of contrast, the resilient protection of through-foundation pipe coupling of the current invention incorporates the resilient and sealing facilities during the foundation forming process. The pipe coupling component is itself an integral part of the through-foundation piping. That is, the fluid that flows through the through-foundation piping can come in direct contact with part of the inside wall of the current invention; whereas the fluid that flows through the through-foundation piping does not come in contact with any part of the “Pipe Wall Sleeve” and “Pipeseal” combination.

U.S. Pat. No. 7,374,210, to Staskal, discloses a resilient sealing barrier (13) in combination with a cast-in rigid sleeve (5 and 6) that likewise serves to protect a separate through-foundation pipe (1).

U.S. Pat. No. 6,792,726, to Price, also discloses a resilient sealing barrier (20) in combination with a cast-in rigid sleeve (10), that serve to protect a separate through-foundation pipe (80).

Some through-foundation systems are provided without resilient means. For example, U.S. Pat. No. 6,101,774, to Heil, discloses rigid members directly in contact with a foundation (e.g., 12, 24), where other rigid piping members (e.g., 14 16) are in slidable fit. U.S. Pat. Nos. 4,619,471, 4,453,354, and 4,313,286 to Harbeke, similarly disclose systems involving rigid cast-in place members in combination with close fitting companion, rigid piping to complete a fluid-flow circuit.

An approach that provides resilient and sealing means, but no through-foundation pipe, is to cast an elastomeric seal into a foundation. U.S. Pat. No. 5,979,908, to Jones, discloses an elastomeric seal or gasket (16) in combination with holders (30) to to facilitate embedding that seal into a wall cast between forms (32). U.S. Pat. No. 5,941,535, to Richard; U.S. Pat. Nos. 5,711,536 and 5,624,123, to Meyers; U.S. Pat. Nos. 3,787,061 and 3,759,285, to Yoakum; and U.S. Pat. No. 5,286,040, to Gavin each represent a variation of the use of a cast-in place resilient and sealing member, to support a later-installed and separate through-foundation pipe.

U.S. Pat. No. 4,261,598, to Cornwall, discloses a cast in place rigid piping member, the inside surface of which will be in contact with the fluid being transferred through the foundation. But the Cornwall disclosure does not involve the use of any elastomeric material to effect resilience between further piping and the foundation.

U.S. Pat. No. 4,420,176, to Cornwall, discloses the use of an elastomeric member for use in connecting and sealing separate sections of pipe in a piping circuit. Elastomeric sealing members (10) cooperate with fittings (100) to connect sections of pipe (e.g., 201-203). As illustrated in FIG. 5, rigid coupling (100) and pipe (204) are in rigid contact with the foundation, with part of the length of elastomeric joint (10e) being retained inside rigid coupling (100), and the remainder of the length of elastomeric joint (10e) extending beyond poured wall or floor (500). Pipe section (210) fits into exposed length of elastomeric joint (10e), effecting a slightly resilient sealed connection between rigid coupling (100) and pipe section (210).

U.S. Pat. No. 5,035,097, to Cornwall, discloses a similar invention, where a rigid sleeve (e.g, 10-10d in FIG. 3) can be in direct contact with a cast foundation (100), and elastomeric members (104, 105) extending beyond the foundation walls, are available to provide resilient and sealing connections to pipe sections (102, 103).

FIG. 4 of the '097 invention resembles the “Pipe Wall Sleeve” and a later installed “Pipeseal” elastomeric body, with coupling (10) being analogous to the “Pipe Wall Sleeve” member, and elastic rings (107, 108) being analogous to the elastomeric “Pipeseal” members.

One way that the present invention differs from the '176 and '097 inventions is that the present invention provides for a resilient and sealing relationship directly between the piping material and the foundation material. Also, in the present invention and unlike the Cornwall inventions, the fluid that courses through the installed piping is never in contact with the resilient layer between the foundation and the through-foundation pipe.

The art of providing plastic piping vertically through foundation floors usually involves wrapping one or more layers of foam insulation material (typically a sheet of Expanded Polyethylene—EPE) around the pipe and securing the foam insulation material to itself with tape. The present invention differs from the practice of simple foam wrapping of a pipe, in that the resilient and sealing elastomeric covering of the present invention is watertight, and is integrated with the pipe coupling. Integration of the resilient layer to the rigid coupling is essential to close off a leak path that would otherwise exist between the resilient layer and the rigid coupling. Integration of the resilient layer to the rigid coupling can be accomplished via adhesive bonding of the resilient layer to the rigid coupling, or by bonding the resilient layer during a molding process.

The need to pass piping through foundation walls, in a fashion that prevents leaks through the foundation and also prevents leaks from through-foundation piping is well known. As described in the above-noted U.S. Patents, the devices and methods for accomplishing those objectives are many and varied.

### SUMMARY OF THE PRESENT INVENTION

The present invention contemplates a section of rigid piping being surrounded by and integrated with an elastomeric material, with that combination of parts in turn being cast or formed in place in a concrete foundation wall or floor.

An objective of the present invention is to eliminate the need to use spray foam or silicone in order to prevent a foundation through-hole from leaking into the below-grade sections of a building.

A further objective of the present invention is to prevent a through-foundation plumbing system from developing cracks and leaks due to slight shifting of the foundation or surrounding soil (such as occurs in freeze/thaw events) or repetitive vibration or motion of the plumbing.

A further objective of the present invention is to provide plumbers with a convenient, inexpensive, and commonly known facility for joining connecting piping to the resiliently-mounted through-foundation pipe coupling.

A further objective of the present invention is to facilitate the use of plastic plumbing in through-foundation applications and directly casting the plastic piping member into the foundation. Attempts to directly cast plastic piping into concrete foundations often results in breakage of the plastic piping, and the resilient layer of the present invention protects the interior plastic piping piece from being directly impinged by the forces of pouring the foundation.

The present invention relates to the resilient protection of through-foundation pipes that may be adapted and adjusted to various pipe sizes and materials, a range of foundation thicknesses, and a range of elastomeric dimensions and properties to obtain the desired or necessary amount of resilience. The present invention may be further adapted to a range of pipe-fitting means. Specific features of the invention will be apparent from the above and from the following description of the illustrative embodiments when considered with the attached drawings and the appended claims.

In summary, and in accordance with the above discussion, the foregoing objectives are achieved in the following embodiments.

1. A method of obtaining a mechanically-resilient intersection between a poured foundation and a through-foundation pipe comprising the steps of:
a) providing a piece of hollow pipe with a length that is about the same as the finished foundation thickness;
b) covering essentially the entire length of outside diameter of the piece of hollow pipe with a layer of elastomeric material;
c) securing the elastomeric-covered piece of hollow pipe in a desired position within a form used to contain the poured foundation; and
d) pouring the foundation.

2. A method of obtaining a mechanically-resilient intersection between a poured foundation and a through-foundation pipe as described in paragraph 1, where:
the piece of hollow pipe is schedule 40 PVC with a diameter of about four inches and a length of between eight and fourteen inches.

3. A method of obtaining a mechanically-resilient intersection between a poured foundation and a through-foundation pipe as described in paragraph 1, where:
step (a) further includes providing a pipe coupling adapted to the piece of hollow pipe and fastening and sealing the pipe coupling to the piece of hollow pipe; and
step (b) further includes covering the outside diameter of the pipe coupling with an elastomeric material.

4. A method of obtaining a mechanically-resilient intersection between a poured foundation and a through-foundation pipe as described in paragraph 1, where the piece of hollow pipe at step (a) is a standard deep double female pipe coupling.

5. A method of obtaining a mechanically-resilient intersection between a poured foundation and a through-foundation pipe as described in paragraph 1, where the layer of elastomeric material at step (b) is a closed cell foam.

6. A method of obtaining a mechanically-resilient intersection between a poured foundation and a through-foundation pipe as described in paragraph 5, where the layer of elastomeric material at step (b) is created by wrapping a sheet of contact-adhesive backed elastomeric material around the outside of the piece of hollow pipe, creating a seam where the ends of the wrapped sheet of elastomeric material meet.

7. A method of obtaining a mechanically-resilient intersection between a poured foundation and a through-foundation pipe as described in paragraph 6, where step (b) further comprises covering the seam with an adhesive-backed plastic tape.

8. A method of obtaining a mechanically-resilient intersection between a poured foundation and a through-foundation pipe as described in paragraph 5, where the layer of elastomeric material at step (b) is at least 6 millimeters (0.24 inch) thick.

9. A method of obtaining a mechanically-resilient intersection between a poured foundation and a through-foundation pipe as described in paragraph 5, where the layer of elastomeric material at step (b) is created by molding the foam in place.

10. A method of obtaining a mechanically-resilient intersection between a poured foundation and a through-foundation pipe as described in paragraph 9, where the layer of elastomeric material at step (b) further comprises circumferential grooves.

### BRIEF DESCRIPTION OF THE DRAWINGS

FIG. 1 is a partial cutaway view of one embodiment of a resiliently-mounted through-foundation pipe coupling according to the present invention.

FIG. 2 is a cutaway view of an alternative embodiment of a resiliently-mountable through-foundation pipe coupling.

FIG. 3 is an end view of the preferred embodiment of a resiliently-mounted through-foundation pipe coupling according to the present invention.

FIG. 3A is a side view of a an elastomeric sheet according to the present invention.

FIG. 4 is a perspective view of the preferred embodiment of a resiliently-mounted through-foundation pipe coupling according to the present invention.

FIG. 5 is a side cutaway view of the preferred embodiment of a resiliently-mounted through-foundation pipe coupling according to the present invention.

FIG. 6 is a side cutaway view of the present invention being retained by elements of a foundation form.

FIG. 7 is a side view of an embodiment of the present invention, with external circumferential grooves.

### DESCRIPTION OF THE PREFERRED EMBODIMENTS OF THE PRESENT INVENTION

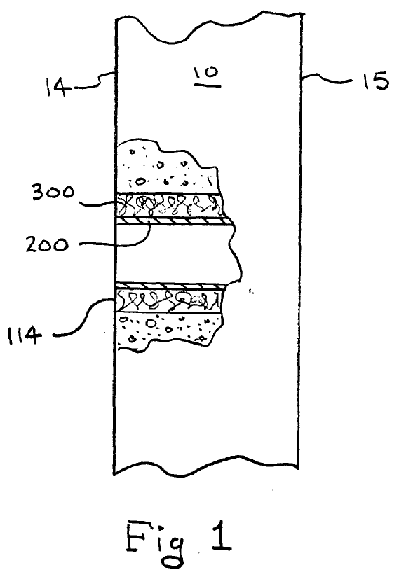

FIG. 1 is a partial cutaway view of one embodiment of a resiliently-mounted through-foundation pipe coupling according to the present invention.

Foundation wall (10) is partially cutaway, revealing part of the length of rigid pipe-coupling (200) and elastomeric layer (300). The length of both rigid pipe coupling (200) and elastomeric layer (300) extend from one side (14) of foundation wall (10) to the other side (15) of foundational wall (10), with one end face (114) of the the resiliently-mounted through-foundation pipe coupling being coplanar with one side (14) of foundation wall (10), and the opposite face of the coupling (not shown or numbered in this view) being coplanar with the opposite side (15) of foundation wall (10).

In the preferred embodiment, the resiliently-mounted through-foundation pipe coupling is made up of a 4 inch diameter schedule 40 PVC “deep” female coupling. This component has a length of about 8 inches, which corresponds with a common foundation wall thickness. This standard piece of plumbing hardware accepts 4 inch diameter PVC pipe for a glue-sealed fit, and has an internal end stop approximately midway along its length.

However, a resiliently-mounted through-foundation pipe coupling of the present invention can be made of any desired diameter (e.g., as small as 0.50 inch and up to 16 inch diameter or larger), and of any desired length, by combining standard PVC pipe with standard PVC pipe couplings.

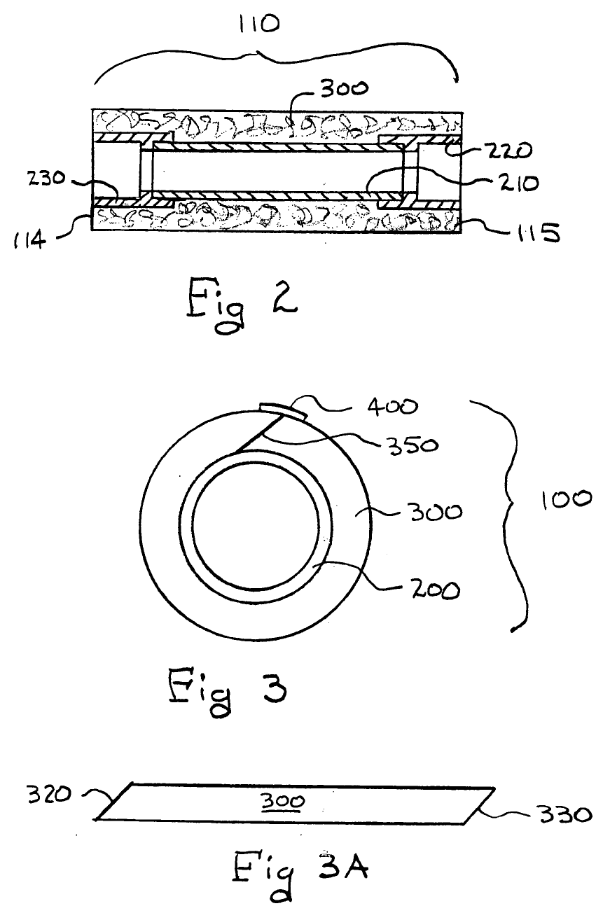

FIG. 2 is a cutaway view of an alternative embodiment of a resiliently-mountable through-foundation pipe coupling.

Resiliently-mountable through foundation pipe coupling (110) is shown as a length of rigid pipe (210) of the desired length, combined with pipe couplings (220 and 230) to make an assembly of the length commensurate with the thickness of foundation to be accommodated. Pipe couplings (210 and 220) are glued to pipe (210) using conventional PVC plumbing materials and techniques similar to the construction shown in FIG. 1, an elastomeric layer (300) is bonded over the entire length of the combination of pipe (210) and couplings (220 and 230), so that each end face (114 and 115) is approximately a single plane comprised partly of rigid pipe (or pipe coupling) (200, 220, or 230) and partly of elastomeric material (300). Where coplanarity of rigid pipe (or pipe coupling) (200, 220, or 230) and elastomeric material (300) are not obtained, the preferred arrangement has the plane of the face of the pipe (or pipe coupling) (200, 220, or 230) slightly recessed from the plane of the end face of the elastomeric material (300). This arrangement facilitates obtaining a good seal between the elastomeric material (300), and the foundation forms, when the resiliently-mounted through-foundation pipe coupling is cast into a foundation.

In the preferred embodiment, elastomeric layer (300) is made of a sheet of contact-adhesive-backed closed cell neoprene. With the preferred pipe diameter of 4 inches, an elastomeric layer thickness of half an inch (about 13 millimeters) has been found to be adequate for most applications. The specific preferred material is SCE-41B or SCE-42B Neoprene/EPDM/SBR blend closed-cell sheet, having a Shore 00 value of 30-50, and a 25% compression deflection of about 5 PSI. 25% compression deflection values in a range of 2 to 9 PSI are suitable for the application.

While the preferred thickness of elastomer is about half an inch (over a 4 inch diameter schedule 40 PVC pipe coupling), and the preferred elastomer has the resilient properties described above, a diverse range of elastomer thickness and stiffness is foreseen as in the scope of the present invention. A thicker layer may be used to accommodate an extended amount of motion due to the size of the through-foundation piping system, and more or less rigid elastomers may be used to accommodate more or less sturdy piping systems.

In addition, while the figures illustrate the use of a flat sheet of elastomeric material, the inventor foresees the possible use of a “ribbed” sheet, in order to produce a finished resiliently-mountable sleeve having circumferential grooves as shown in FIG. 7.

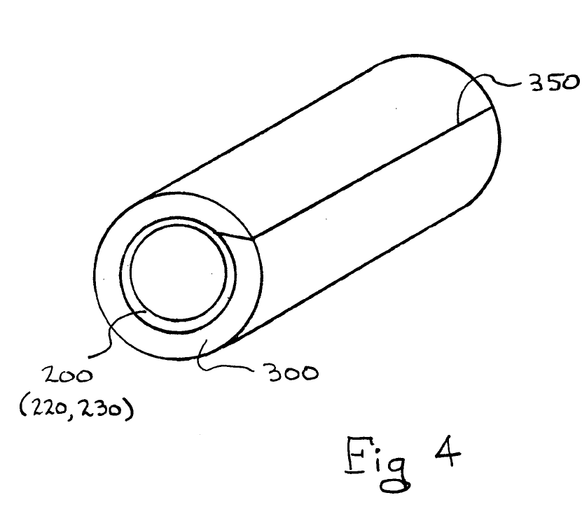

FIG. 3 is an end view of the preferred embodiment of a resiliently-mounted through-foundation pipe coupling according to the present invention.

FIG. 3A is a side view of a an elastomeric sheet according to the present invention.

In FIG. 3, the sheet of elastomeric material (300) is shown wrapped around pipe coupling (200), forming a seam (350) where the ends of the elastomeric sheet (300) meet. In order to insure that there is no leak path between end faces (114) and (115) (shown in FIG. 2), seam (350) is preferably cut at an angle, and contacted edges (320 and 330) of elastomeric sheet (300) are bound together at seam (350) by a piece of polyester film tape having contact adhesive on both sides. The contact adhesive on the polyester tape is the same adhesive that is used to bond the elastomeric foam material (300) to pipe coupling (200). In addition to sealing contact edge (320) to contact edge (330), in the preferred embodiment, a piece of adhesive tape (400) is used to cover the exposed line of seam (350) that appears on the outside diameter of elastomeric layer (300).

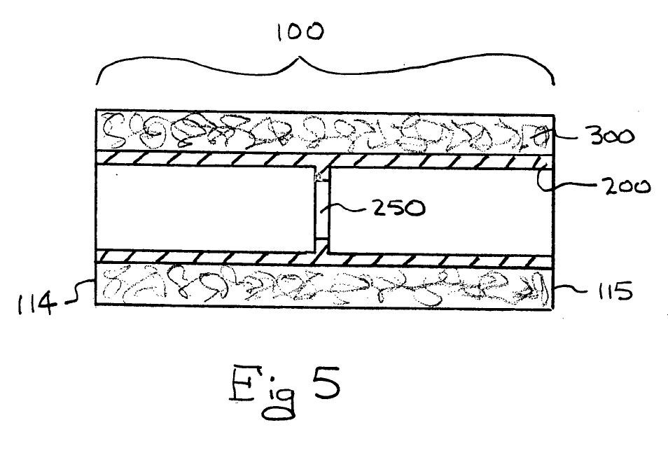

FIG. 4 is a perspective view of the preferred embodiment of a resiliently-mounted through-foundation pipe coupling according to the present invention.

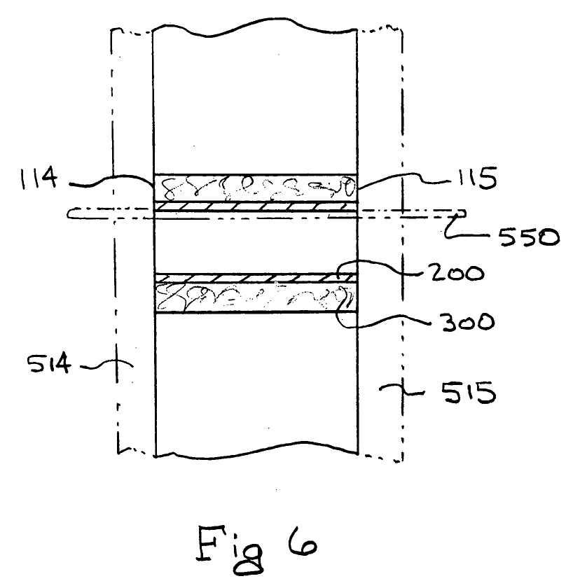

The preferred use of a wrapped elastomeric layer (300), and its consequent seam (350) is illustrated, with the elastomeric layer (300) being over either a unitary pipe coupling (200 as shown in FIGS. 1 and 5) or a multi-piece pipe coupling (220 or 230 as shown in FIG. 2).

FIG. 5 is a side cutaway view of the preferred embodiment of a resiliently-mounted through-foundation pipe coupling according to the present invention.

Unitary pipe coupling (200) is combined with elastomeric layer (300) to make resiliently-mounted through-foundation pipe coupling (100). Pipe coupling (200) contains an integral end stop (250), located approximately mid-way along the length of pipe coupling (200).

However, an alternative embodiment is foreseen, wherein pipe coupling (200) has no integral stop, (250), and instead, presents a continuous inside diameter from end face (114) to end face (115).

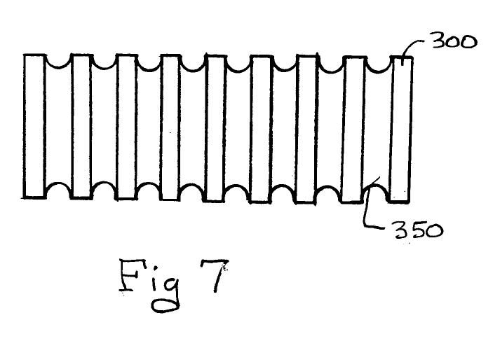

FIG. 6 is a side cutaway view of the present invention being retained by elements of a foundation form.

A resiliently-mounted through-foundation pipe coupling, comprising elastomeric layer (300) and pipe coupling (200) is shown trapped between foundation form members (514) and (515). Space (50) between foundation form members (514) and (515) will be filled with concrete to make a foundation wall. In addition to being trapped between the foundation form members (514 and 515), the resiliently-mounted through-foundation pipe coupling will preferably rest on a concrete form tie (550) or otherwise be restrained from being dislodged during the foundation pouring activity. After the foundation has cured, concrete form tie (550) is easily removed, because it resides in the open space inside pipe coupling (200), and hasn't been cast into the foundation.

The interior hole of pipe coupling (200) is kept free of concrete as elastomeric layer (300) effectively seals against foundation form members (514 and 515).

FIG. 7 is a side view of an embodiment of the present invention, with external circumferential grooves.

An alternative to wrapping a flat sheet of elastomeric material around a rigid pipe or pipe coupling, and then sealing the seam, is to mold a layer of suitable foam over the pipe or pipe coupling.

The elastomeric material covering the through foundation pipe coupling may be ribbed or grooved to facilitate being held in place within the cast concrete foundation. Circumferential grooves (350), or ribs (not illustrated) in elastomeric material (300) would serve to provide additional axial retention between the resiliently-mounted through-foundation pipe coupling and the concrete of the foundation.

It is particularly noted that while the figures and description show a resiliently-mounted through-foundation pipe coupling in a horizontal position, and describe properties associated with passing through a wall, the present invention is equally applicable to through-floor foundation penetrations.

The present invention, described above, relates to the resilient protection of through-foundation pipes. Features of the present invention are recited in the appended claims. The drawings contained herein necessarily depict structural features and embodiments of the resilient protection of through-foundation pipes, useful in the practice of the present invention.

However, it will be appreciated by those skilled in the arts pertaining thereto,: that the present invention can be practiced in various alternate forms, proportions, and configurations. Further, the previous detailed descriptions of the preferred embodiments of the present invention are presented for purposes of clarity of understanding only, and no unnecessary limitations should be implied therefrom. Finally, all appropriate mechanical and functional equivalents to the above, which may be obvious to those skilled in the arts pertaining thereto, are considered to be encompassed within the claims of the present invention.

What I claim is:

1. A method of obtaining a mechanically-resilient intersection between a poured foundation and a through-foundation pipe comprising the steps of:
a) providing a piece of hollow pipe with a length that is about the same as the finished foundation thickness;
b) covering essentially the entire length of outside diameter of the piece of hollow pipe with a layer of elastomeric material;
c) securing the elastomeric-covered piece of hollow pipe in a desired position within a form used to contain the poured foundation; and
d) pouring the foundation.

2. A method of obtaining a mechanically-resilient intersection between a poured foundation and a through-foundation pipe as described in claim 1, where:
the piece of hollow pipe is schedule 40 PVC with a diameter of about four inches and a length of between eight and fourteen inches.

3. A method of obtaining a mechanically-resilient intersection between a poured foundation and a through-foundation pipe as described in claim 1, where:
step (a) further includes providing a pipe coupling adapted to the piece of hollow pipe and fastening and sealing the pipe coupling to the piece of hollow pipe; and
step (b) further includes covering the outside diameter of the pipe coupling with an elastomeric material.

4. A method of obtaining a mechanically-resilient intersection between a poured foundation and a through-foundation pipe as described in claim 1, where the piece of hollow pipe at step (a) is a standard deep double female pipe coupling.

5. A method of obtaining a mechanically-resilient intersection between a poured foundation and a through-foundation pipe as described in claim 1, where the layer of elastomeric material at step (b) is a closed cell foam.

6. A method of obtaining a mechanically-resilient intersection between a poured foundation and a through-foundation pipe as described in claim 5, where the layer of elastomeric material at step (b) is created by wrapping a sheet of contact-adhesive backed elastomeric material around the outside of the piece of hollow pipe, creating a seam where the ends of the wrapped sheet of elastomeric material meet.

7. A method of obtaining a mechanically-resilient intersection between a poured foundation and a through-foundation pipe as described in claim 6, where step (b) further comprises covering the seam with an adhesive-backed plastic tape.

8. A method of obtaining a mechanically-resilient intersection between a poured foundation and a through-foundation pipe as described in claim 5, where the layer of elastomeric material at step (b) is at least 6 millimeters (0.24 inch) thick.

9. A method of obtaining a mechanically-resilient intersection between a poured foundation and a through-foundation pipe as described in claim 5, where the layer of elastomeric material at step (b) is created by molding the foam in place.

10. A method of obtaining a mechanically-resilient intersection between a poured foundation and a through-foundation pipe as described in claim 9, where the layer of elastomeric material at step (b) further comprises circumferential grooves.
